(19) United States
(12) Patent Application Publication
(10) Pub. No.: US 2025/0096959 A1
(43) Pub. Date: Mar. 20, 2025

(54) TECHNIQUES FOR SOUNDING REFERENCE SIGNAL MULTIPLEXING DURING BANDWIDTH PART HOPPING

(71) Applicant: QUALCOMM Incorporated, San Diego, CA (US)

(72) Inventors: Iyab Issam SAKHNINI, San Diego, CA (US); Chao WEI, Beijing (CN); Tao LUO, San Diego, CA (US)

(21) Appl. No.: 18/580,396

(22) PCT Filed: Sep. 17, 2021
(86) PCT No.: PCT/CN2021/119128

§ 371 Date: Jan. 18, 2024

(51) Int. Cl. H04L 5/00; H04W 72/231

(52) U.S. Cl. CPC H04L 5/0012; H04L 5/0051; H04W 72/231

(57) ABSTRACT

Various aspects of the present disclosure generally relate to wireless communication. In some aspects, a first user equipment (UE) may receive a bandwidth part (BWP) frequency hopping configuration for a BWP and a first configuration of a sounding reference signal (SRS) resource. The UE may receive a second configuration of the SRS resource for one or more frequency hops of the BWP frequency hopping configuration, wherein the second configuration resolves a partial overlap of the SRS resource with an SRS resource of a second UE in the one or more frequency hops. The UE may transmit one or more SRSs based at least in part on the second configuration of the SRS resource. Numerous other aspects are described.

### FIELD OF THE DISCLOSURE

Aspects of the present disclosure generally relate to wireless communication and to techniques and apparatuses for sounding reference signal multiplexing during bandwidth part hopping.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a first user equipment (UE). The method may include receiving a bandwidth part (BWP) frequency hopping configuration for a BWP. The method may include receiving a first configuration of a sounding reference signal (SRS) resource. The method may include receiving a second configuration of the SRS resource for one or more frequency hops of the BWP frequency hopping configuration. The method may include transmitting one or more SRSs based at least in part on the second configuration of the SRS resource.

Some aspects described herein relate to a method of wireless communication performed by a base station. The method may include transmitting, to a first UE, a BWP frequency hopping configuration. The method may include transmitting, to the first UE, a first configuration of a SRS resource. The method may include transmitting a second configuration of the SRS resource for the one or more frequency hops of the BWP frequency hopping configuration. The method may include receiving one or more SRSs based at least in part on the second configuration of the SRS resource.

Some aspects described herein relate to a first UE for wireless communication. The first UE may include a memory and one or more processors coupled to the memory. The one or more processors may be configured to receive a BWP frequency hopping configuration for a BWP. The one or more processors may be configured to receive a first configuration of an SRS resource. The one or more processors may be configured to receive a second configuration of the SRS resource for one or more frequency hops of the BWP frequency hopping configuration. The one or more processors may be configured to transmit one or more SRSs based at least in part on the second configuration of the SRS resource.

Some aspects described herein relate to a base station for wireless communication. The base station may include a memory and one or more processors coupled to the memory. The one or more processors may be configured to transmit, to a first UE, a BWP frequency hopping configuration. The one or more processors may be configured to transmit, to a first UE, a first configuration of an SRS resource. The one or more processors may be configured to transmit a second configuration of the SRS resource for the one or more frequency hops of the BWP frequency hopping configuration. The one or more processors may be configured to receive one or more SRSs based at least in part on the second configuration of the SRS resource.

Some aspects described herein relate to a non-transitory computer-readable medium that stores a set of instructions for wireless communication by a first UE. The set of instructions, when executed by one or more processors of the UE, may cause the UE to receive a BWP frequency hopping configuration for a BWP. The set of instructions, when executed by one or more processors of the UE, may cause the UE to receive a first configuration of a SRS resource. The set of instructions, when executed by one or more processors of the UE, may cause the UE to receive a second configuration of the SRS resource for one or more frequency hops of the BWP frequency hopping configuration. The set of instructions, when executed by one or more processors of the UE, may cause the UE to transmit one or more SRSs based at least in part on the second configuration of the SRS resource.

Some aspects described herein relate to a non-transitory computer-readable medium that stores a set of instructions for wireless communication by a base station. The set of instructions, when executed by one or more processors of the base station, may cause the base station to transmit, to a first UE, a BWP frequency hopping configuration. The set of instructions, when executed by one or more processors of the base station, may cause the base station to transmit, to the first UE, a first configuration of a SRS resource. The set of instructions, when executed by one or more processors of the base station, may cause the base station to transmit a second configuration of the SRS resource for the one or more frequency hops of the BWP frequency hopping configuration based at least in part on determining that the SRS resource partially overlaps with the SRS resource of the second UE. The set of instructions, when executed by one or more processors of the base station, may cause the base station to receive one or more SRSs based at least in part on the second configuration of the SRS resource.

Some aspects described herein relate to an apparatus for wireless communication. The apparatus may include means for receiving a BWP frequency hopping configuration for a BWP. The apparatus may include means for receiving a first configuration of a SRS resource of the apparatus. The apparatus may include means for receiving a second configuration of the SRS resource of the apparatus for one or more frequency hops of the BWP frequency hopping configuration. The apparatus may include means for transmitting one or more SRSs based at least in part on the second configuration of the SRS resource of the apparatus.

Some aspects described herein relate to an apparatus for wireless communication. The apparatus may include means for transmitting, to a first UE, a BWP frequency hopping configuration. The apparatus may include means for transmitting, to a first UE, a first configuration of a SRS resource. The apparatus may include means for transmitting a second configuration of the SRS resource for the one or more frequency hops of the BWP frequency hopping configuration. The apparatus may include means for receiving one or more SRSs based at least in part on the second configuration of the SRS resource.

Aspects generally include a method, apparatus, system, computer program product, non-transitory computer-readable medium, user equipment, base station, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of BWP frequency hopping, in accordance with the present disclosure.

FIG. 4 is a diagram illustrating an example of SRS resource sets, in accordance with the present disclosure.

FIG. 5 is a diagram illustrating an example associated with SRS multiplexing during BWP part hopping, in accordance with the present disclosure.

FIG. 6 is a diagram illustrating an example associated with SRS resource configuration, in accordance with the present disclosure.

FIG. 7 is a diagram illustrating an example process associated with sounding reference signal multiplexing during bandwidth part hopping, in accordance with the present disclosure.

FIG. 8 is a diagram illustrating an example process associated with sounding reference signal multiplexing during bandwidth part hopping, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

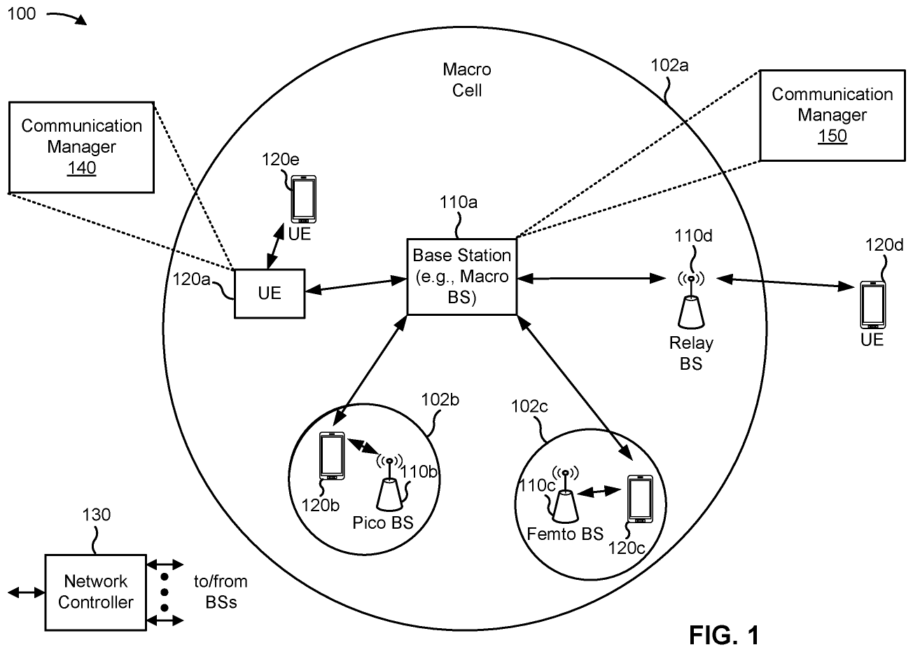

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the base station 110 may serve different UEs 120 of different categories and/or different UEs 120 that support different capabilities. For example, the base station 110 may serve a first category of UEs 120 that have a less advanced capability (e.g., a lower capability and/or a reduced capability) and a second category of UEs 120 that have a more advanced capability (e.g., a higher capability). A UE 120 of the first category may have a reduced feature set compared to UEs 120 of the second category, and may be referred to as a reduced capability (RedCap) UE, a low tier UE, and/or an NR-Lite UE, among other examples. A UE 120 of the first category may be, for example, an MTC UE, an eMTC UE, and/or an IoT UE. A UE 120 of the second category may have an advanced feature set compared to UEs 120 of the second category, and may be referred to as a baseline UE, a high tier UE, an NR UE, an enhanced mobile broadband (eMBB) UE, and/or a premium UE, among other examples. In some aspects, a UE 120 of the first category has capabilities that satisfy requirements of a first (earlier) wireless communication standard but not a second (later) wireless communication standard, while a UE 120 of the second category has capabilities that satisfy requirements of the second (later) wireless communication standard (and also the first wireless communication standard, in some cases).

For example, UEs 120 of the first category may support a lower maximum modulation and coding scheme (MCS) than UEs 120 of the second category (e.g., quadrature phase shift keying (QPSK) or the like as compared to 256-quadrature amplitude modulation (QAM) or the like), may support a lower maximum transmit power than UEs 120 of the second category, may have a less advanced beamforming capability than UEs 120 of the second category (e.g., may not be capable of forming as many beams as UEs of the second category), may require a longer processing time than UEs 120 of the second category, may include less hardware than UEs 120 of the second category (e.g., fewer antennas, fewer transmit antennas, and/or fewer receive antennas), and/or may not be capable of communicating on as wide of a maximum bandwidth part as UEs 120 of the second category, among other examples. Additionally, or alternatively, UEs 120 of the second category may be capable of communicating using a shortened transmission time interval (TTI) (e.g., a slot length of 1 ms or less, 0.5 ms, 0.25 ms, 0.125 ms, 0.0625 ms, or the like, depending on a sub-carrier spacing), and UEs 120 of the first category may not be capable of communicating using the shortened TTI.

In some aspects, the UE 120 may include a communication manager 140. As described in more detail elsewhere herein, the communication manager 140 may receive a bandwidth part (BWP) frequency hopping configuration; receive an indication to update a configuration of a sounding reference signal (SRS) resource for one or more frequency hops of the BWP frequency hopping configuration, wherein the SRS resource partially overlaps with an SRS resource of a second UE 120 in the one or more frequency hops; and transmit one or more SRSs based at least in part on the updated configuration of the SRS resource. Additionally, or alternatively, the communication manager 140 may perform one or more other operations described herein.

In some aspects, the base station 110 may include a communication manager 150. As described in more detail elsewhere herein, the communication manager 150 may transmit, to a first UE 120, a BWP frequency hopping configuration; identify that an SRS resource partially overlaps with an SRS resource of a second UE 120 for one or more frequency hops of the BWP frequency hopping configuration; transmit an indication to update a configuration of an SRS resource for the one or more frequency hops of the BWP frequency hopping configuration based at least in part on identifying that the SRS resource partially overlaps with the SRS resource of the second UE 120; and receive one or more SRSs based at least in part on the updated configuration of the SRS resource. Additionally, or alternatively, the communication manager 150 may perform one or more other operations described herein.

As indicated above, FIG. 1 is provided as an example. Other examples may differ from what is described with regard to FIG. 1.

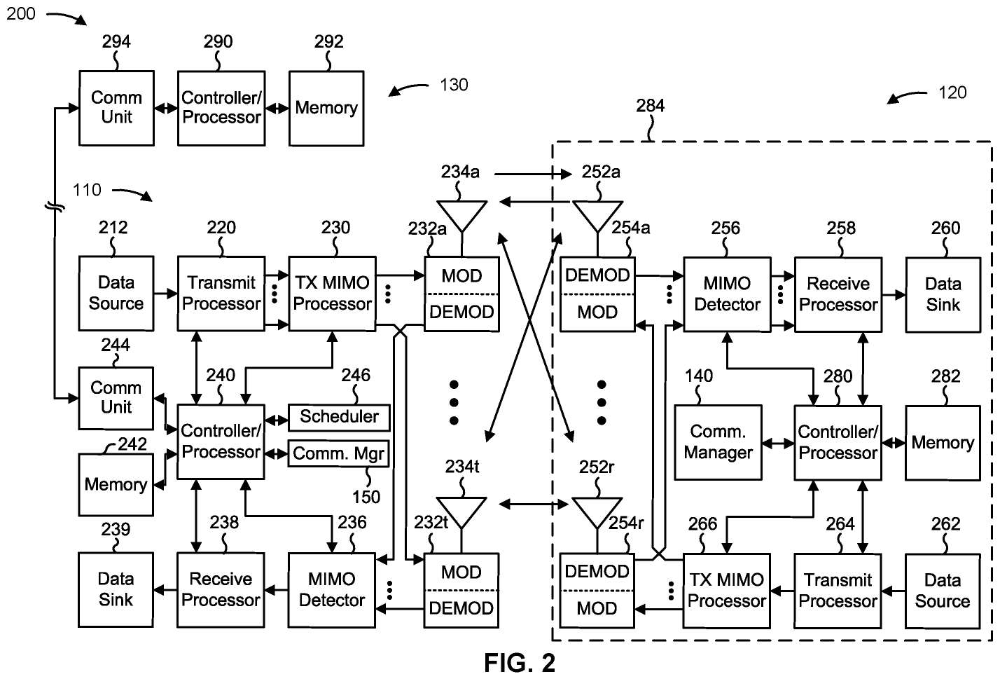

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

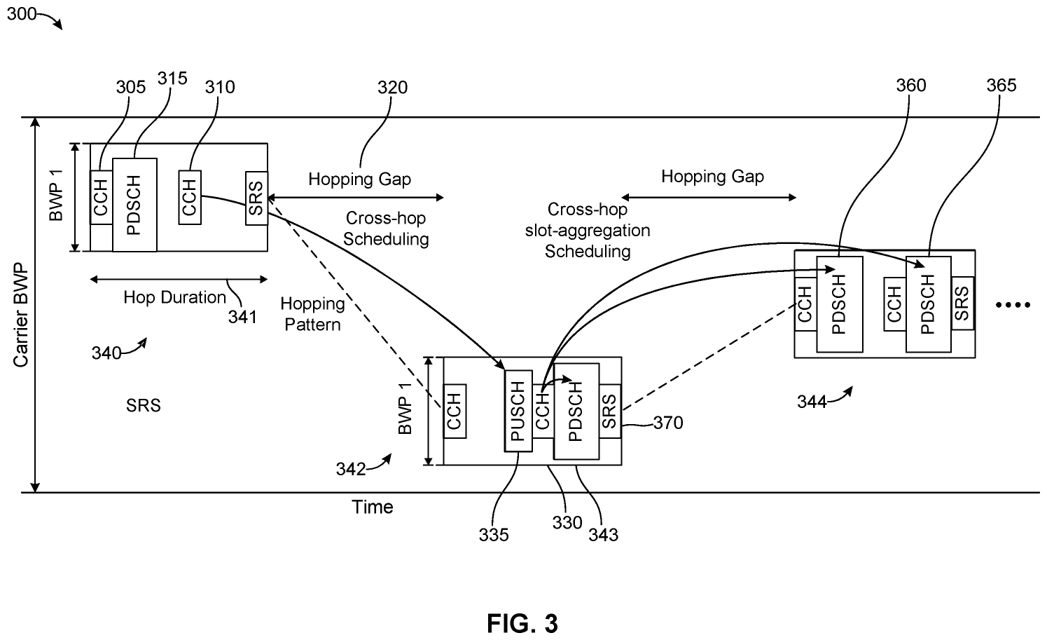

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3-10).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3-10).

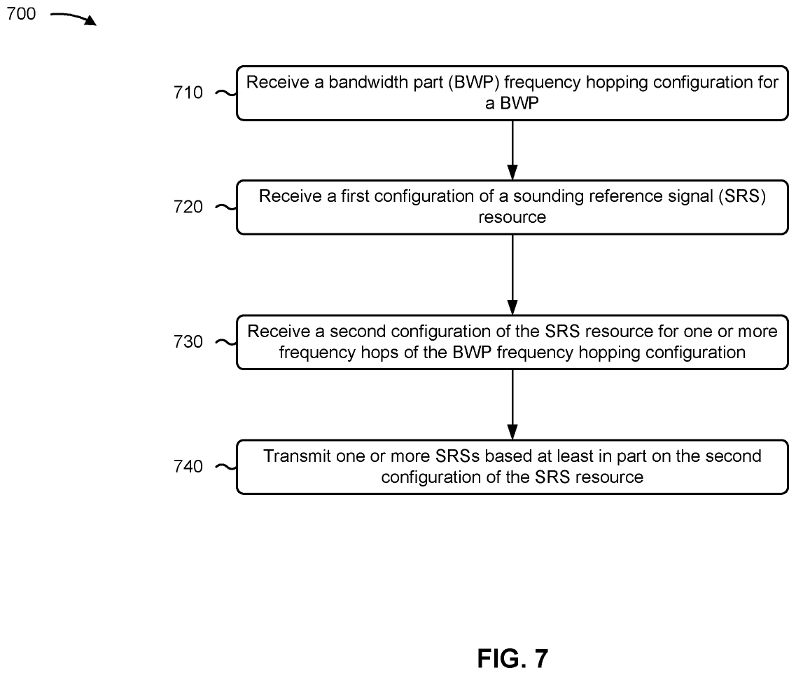

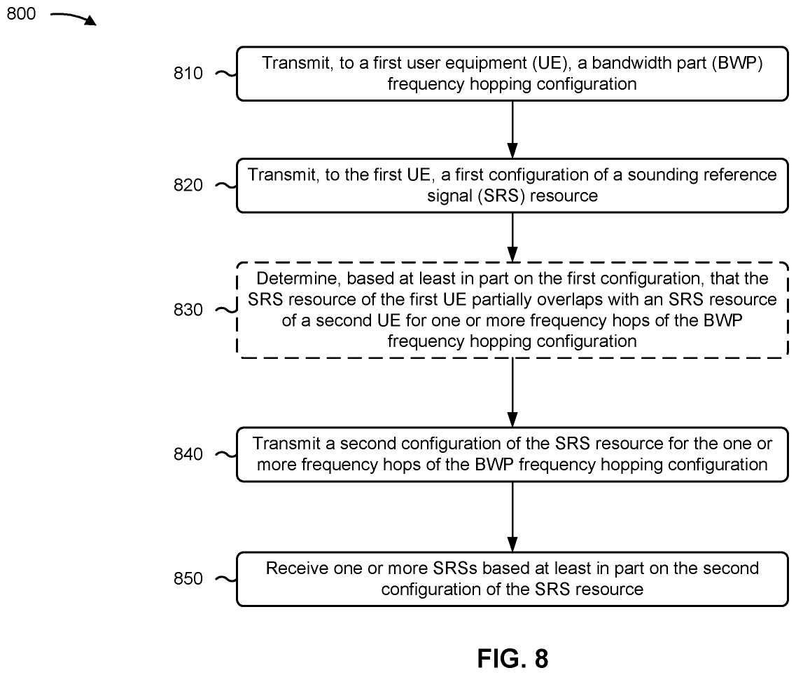

The controller/processor 240 of the base station 110, the controller/processor 280 of the UE 120, and/or any other component(s) of FIG. 2 may perform one or more techniques associated with sounding reference signal multiplexing during bandwidth part hopping, as described in more detail elsewhere herein. For example, the controller/processor 240 of the base station 110, the controller/processor 280 of the UE 120, and/or any other component(s) of FIG. 2 may perform or direct operations of, for example, process 700 of FIG. 7, process 800 of FIG. 8, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, the first UE 120 includes means for receiving a BWP frequency hopping configuration for a BWP and a first configuration of a SRS resource; means for receiving a second configuration of the SRS resource for one or more frequency hops of the BWP frequency hopping configuration, wherein the second configuration resolves a partial overlap of the SRS resource with an SRS resource of a second UE 120 in the one or more frequency hops; and/or means for transmitting one or more SRSs based at least in part on the second configuration of the SRS resource. The means for the first UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the base station 110 includes means for transmitting, to a first UE 120, a BWP frequency hopping configuration and a first configuration of a SRS resource; means for determining, based at least in part on the first configuration, that the SRS resource of the first UE partially overlaps with an SRS resource of a second UE 120 for one or more frequency hops of the BWP frequency hopping configuration; means for transmitting a second configuration of the SRS resource for the one or more frequency hops of the BWP frequency hopping configuration based at least in part on determining that the SRS resource of the first UE 120 partially overlaps with the SRS resource of the second UE 120; and/or means for receiving one or more SRSs based at least in part on the second configuration of the SRS resource of the first UE 120. The means for the base station 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

FIG. 3 is a diagram illustrating an example 300 of bandwidth part (BWP) frequency hopping, in accordance with the present disclosure. “BWP frequency hopping” is sometimes referred to herein as “frequency hopping” or “BWP hopping.” In some aspects, frequency hopping may be used to improve frequency diversity within a narrow band of operation and to reduce or eliminate frequency-selective interference. For example, intra-BWP frequency hopping may be implemented for a physical uplink control channel (PUCCH) and a physical uplink shared channel (PUSCH) in certain implementations. In some aspects, cross-BWP scheduling for downlink (DL) signaling may be implemented. For example, cross-BWP scheduling may be employed by using control signaling in one BWP to schedule resources in another BWP.

To facilitate reduced bandwidth (BW) operation, a narrow BWP (NBWP) may be deployed in certain configurations. For example, after connection establishment (e.g., of an initial BWP), a UE may switch to a NBWP among multiple NBWPs to reduce radio frequency (RF) power consumption. A NBWP may be utilized by a UE having one or more reduced capabilities, such as the RedCap UE described above in connection with FIG. 1 and described further herein. In some aspects, the NBWP BW has a maximum bandwidth of 100 MHz.

As shown in FIG. 3, a single BWP (e.g., BWP1) may be configured with BWP frequency hopping. In some aspects, BWP1 may be a NBWP. BWP1 may have associated configurations, such as configurations for a physical downlink control channel (PDCCH), a physical downlink shared channel (PDSCH), a PUCCH, PUSCH, and reference signals (RS), such as a channel state information (CSI)-RS. For example, control channel (CCH) 305 during frequency hop 340 may be used to configure resources for PDSCH 315 to be received by a UE during frequency hop 340. A BWP that is configured with BWP frequency hopping may have a frequency allocation that varies over time. For example, the frequency allocation may be dependent on a hopping pattern of the BWP, as described below. A BWP that is configured with BWP frequency hopping can be contrasted with a non-hopping BWP, which may have a configured frequency allocation that does not vary over time.

In some aspects, a frequency location of a BWP during each of multiple frequency hops may be determined. For any associated configuration with the BWP, a frequency-domain resource allocation (if any) may be configured with respect to a reference point (e.g., a reference frequency location) within the BWP. The reference point may be the physical resource block (PRB) with the lowest index in the BWP. Regardless of the absolute frequency location of the BWP (e.g., which may be time-varying due to the BWP frequency hopping), the same relative position of resources within the BWP may be maintained. For example, a configuration of CSI-RS and random access channel (RACH) resources may be modified using the corresponding resources' relative position.

In some aspects, the associated procedures for the BWP may be transparent to the frequency hopping. For example, HARQ processes may be maintained across frequency hops (e.g., without dropping of HARQ feedback across frequency hops). In other words, PDSCH 315 may be received by a UE during frequency hop 340, but the acknowledgment for the PDSCH 315 may be transmitted by the UE (e.g., PUCCH) during a different frequency hop (e.g., frequency hop 342).

In some aspects, various timers such as discontinuous reception (DRX) timers, BWP inactivity timers, data inactivity timers, etc. may not be impacted by the frequency hopping. In other words, the timers may continue even though the BWP frequency has changed from one hop to another.

In some aspects, a symbol-wise or slot-wise transition gap may be configured between frequency hops. Slot counting (e.g., scheduling offset) and/or timers may be suspended during the gap between adjacent frequency hops. For example, a frequency hopping gap 320 may exist between frequency hops 340, 342. The frequency hopping gap 320 may be configured to allow time for RF front-end circuitry of the UE to be reconfigured for the new frequency location of the BWP.

In some aspects, frequency hopping may be implemented using a fixed offset. For example, frequency hopping may be from a reference point (e.g., N_{BWP,0}^{start}) (e.g., reference frequency location) based at least in part on a predetermined or configured frequency offset ΔN_{BWP,i}^{start}. That is, the frequency location at the i^{th} frequency hop (e.g., i being an integer equal to or greater than 1) may be determined based at least in part on the equation:

$${N}_{BWP , i}^{start} = ( {N}_{BWP , 0}^{start} + i \cdot Δ {N}_{BWP} ) mod {N}_{total}$$

where/start N_{BWP,i}^{start} is the frequency location of the BWP during frequency hop i, N_{BWP,0}^{start} the frequency location of the reference point (e.g., frequency location of a reference BWP for i=0), ΔN_{BWP} is the configured fixed frequency offset, and Nₜₒₜₐₗ is the total number of frequency hops of the BWP.

In some aspects, the frequency hopping may be implemented using a predetermined or configured sequence. For example, the frequency hopping may be calculated from a reference point N_{BWP,0}^{start} start based at least in part on a predetermined or configured sequence {ΔN_{BWP,0}, . . . , ΔN_{BWP,K-1}}. The frequency location at the 7th frequency hop may then be determined based at least in part on equation:

$${N}_{BWP , i}^{start} = ( {N}_{BWP , 0}^{start} + i \cdot Δ {N}_{BWP , i} ) mod {N}_{total} .$$

In some aspects, additional parameters for the frequency hopping may be configured, such as the frequency hop duration (e.g., hop duration 341 as illustrated in FIG. 3) and the gap between frequency hops (e.g., gap 320 as illustrated in FIG. 3). In some aspects, a UE may report its capability and/or preference on parameters for the frequency hopping to facilitate configuration of the BWP frequency hopping. As used herein, a frequency hop refers to a set of time and frequency resources of a BWP during a hop duration. For example, frequency hop 340 includes the BW of BWP1 and a time duration defined by hop duration 341. Thus, a communication in frequency hop 340 may occur within BWP1 and within the hop duration 341.

In some aspects, cross-hop scheduling may be implemented. For example, CCH 310 may be used to configure resources for communication during a different frequency hop, such as the PUSCH 335 during frequency hop 342, as indicated by the arrow from the CCH 310 to the PUSCH 335. In some aspects, cross-hop slot aggregation may be implemented. For example, CCH 330 may allocate resources for PDSCH 343 during frequency hop 342 and resources for PDSCHs 360, 365 that are during frequency hop 344. The PDSCHs 343, 360, 365 may include the same data, or different redundancy versions of the same data, allowing for aggregation of the data for decoding.

In some aspects, cross-hop aperiodic-CSI (A-CSI) triggering may be implemented. For example, during frequency hop 340, the UE may receive control information triggering measurement of CSI-RS (e.g., for A-CSI measurement) and perform the measurement based at least in part on the CSI-RS received during frequency hop 342, and transmit a report of the measurement during frequency hop 344. In some aspects, cross-hop CSI measurement and reporting may be implemented. For example, periodic or semi-persistent CSI measurement and reporting may be configured. Thus, a UE may perform measurement based at least in part on CSI-RS received during frequency hop 340, but transmit a report the measurement during frequency hop 342.

In some cases, cross-hop quasi-co location (QCL) (e.g., QCL-TypeD) may be implemented. For example, by allowing cross-hop CSI measurement and reporting, QCL relationships of signaling (QCL relation of CSI-RS) may be defined across frequency hops. For example, signals communicated via different frequency hops may be quasi-co located with respect to Doppler shift, Doppler spread, average delay, delay spread, and/or spatial parameters.

In some aspects, cross-hop HARQ feedback may be implemented. In other words, HARQ processes may be maintained across frequency hops (e.g., without dropping of HARQ feedback across the frequency hops). For example, PDSCH 315 may be received by a UE during frequency hop 340, but the acknowledgment for the PDSCH 315 may be transmitted by the UE during a different frequency hop (e.g., frequency hop 342).

BWP frequency hopping may be used to improve frequency diversity within a narrow band of operation and to reduce or eliminate frequency-selective interference. As described further herein, this may be of particular importance when operating within a NBWP, such as by a RedCap UE.

As shown by reference number 370, the BWP1 may be configured with an SRS. For example, the UE may receive a configuration of an SRS resource. The configuration of the SRS resource may “hop with” the BWP1, meaning that the SRS resource is in the same relative location in each of the frequency hops of example 300. There are situations where the BWP1 may hop to a frequency position where the SRS resource is overlapped with an SRS resource of another UE in a way that degrades orthogonality of SRSs transmitted on the SRS resources. Techniques described herein improve the coexistence of UEs utilizing BWP frequency hopping and UEs using a fixed (e.g., non-frequency-hopping) BWP by configuring one or more SRS resources so that the one or more SRS resources do not interfere with SRS resources of a UE using a fixed BWP.

As indicated above, FIG. 3 is provided as an example. Other examples may differ from what is described with regard to FIG. 3.

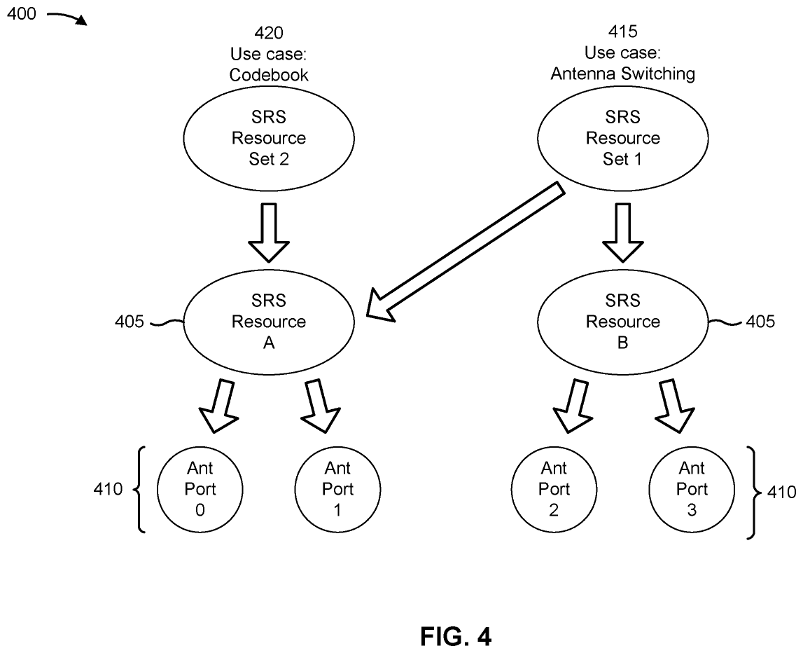

FIG. 4 is a diagram illustrating an example 400 of SRS resource sets, in accordance with various aspects of the present disclosure.

A base station 110 may configure a UE 120 with one or more sounding resource signal (SRS) resource sets to allocate resources for SRS transmissions by the UE 120. For example, a configuration for SRS resource sets may be indicated in a radio resource control (RRC) message (e.g., an RRC configuration message, an RRC reconfiguration message, and/or the like). As shown by reference number 405, an SRS resource set may include one or more resources (e.g., shown as SRS resources), which may include time resources and/or frequency resources (e.g., a slot, a symbol, a resource block, a periodicity for the time resources, and/or the like).

An SRS may be used for uplink channel estimation, such as for scheduling, link adaptation, precoder selection, or beam management, among other examples. The base station 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, or uplink beam management, among other examples. The base station 110 may measure the SRSs, may perform channel estimation based at least in part on the measurements, and may use the SRS measurements to configure communications with the UE 120. In some aspects, the configuration for an SRS resource set may indicate a use case (e.g., in an SRS-SetUse information element) for the SRS resource set. For example, an SRS resource set may have a use case of antenna switching, codebook, non-codebook, beam management, and/or the like.

As shown by reference number 410, an SRS resource may include one or more antenna ports on which an SRS is to be transmitted (e.g., in a time-frequency resource). Thus, a configuration for an SRS resource set may indicate one or more time-frequency resources in which an SRS is to be transmitted and may indicate one or more antenna ports on which the SRS is to be transmitted in those time-frequency resources.

An antenna switching SRS resource set may be used to indicate downlink CSI with reciprocity between an uplink and downlink channel. For example, when there is reciprocity between an uplink channel and a downlink channel, a base station 110 may use an antenna switching SRS (e.g., an SRS transmitted using a resource of an antenna switching SRS resource set) to acquire downlink CSI (e.g., to determine a downlink precoder to be used to communicate with the UE 120).

A codebook SRS resource set may be used to indicate uplink CSI when a base station 110 indicates an uplink precoder to the UE 120. For example, when the base station 110 is configured to indicate an uplink precoder to the UE 120 (e.g., using a precoder codebook), the base station 110 may use a codebook SRS (e.g., an SRS transmitted using a resource of a codebook SRS resource set) to acquire uplink CSI (e.g., to determine an uplink precoder to be indicated to the UE 120 and used by the UE 120 to communicate with the base station 110). In some aspects, virtual ports (e.g., a combination of two or more antenna ports) with a maximum transmit power may be supported at least for a codebook SRS.

A non-codebook SRS resource set may be used to indicate uplink CSI when the UE 120 selects an uplink precoder (e.g., instead of the base station 110 indicated an uplink precoder to be used by the UE 120. For example, when the UE 120 is configured to select an uplink precoder, the base station 110 may use a non-codebook SRS (e.g., an SRS transmitted using a resource of a non-codebook SRS resource set) to acquire uplink CSI. The non-codebook SRS may be precoded using a precoder selected by the UE 120 (e.g., which may be indicated to the base station 110).

A beam management SRS resource set may be used for indicating CSI for millimeter wave communications.

An SRS resource may be configured as periodic, semi-persistent (sometimes referred to as semi-persistent scheduling (SPS)), or aperiodic. A periodic SRS resource may be configured via a configuration message that indicates a periodicity of the SRS resource (e.g., a slot-level periodicity, where the SRS resources occurs every Y slots) and a slot offset. In some cases, a periodic SRS resource may always be activated, and may not be dynamically activated or deactivated. A semi-persistent SRS resource may also be configured via a configuration message that indicates a periodicity and a slot offset for the semi-persistent SRS resource, and may be dynamically activated and deactivated (e.g., using DCI or a medium access control (MAC) control element (CE) (MAC-CE)). An aperiodic SRS resource may be triggered dynamically, such as via DCI (e.g., UE-specific DCI or group common DCI) or a MAC-CE.

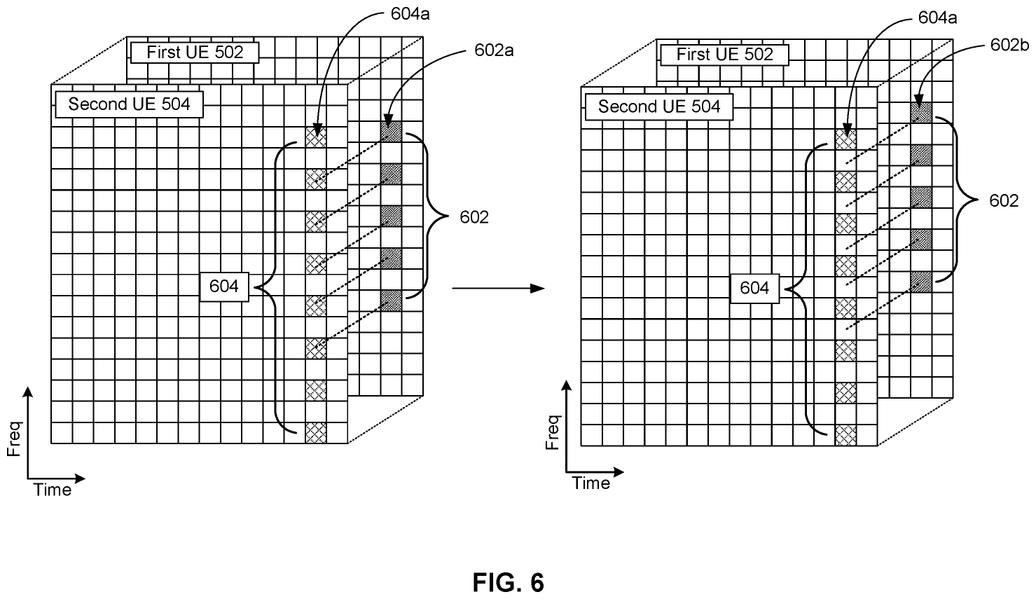

In some aspects, the SRS resource has a comb structure in the frequency domain. In other words, the SRS resource is transmitted every N^{th} subcarrier. For example, N may be equal to 2 (e.g., the SRS resource is transmitted on every other subcarrier) or 4 (e.g., the SRS resource is transmitted on every fourth subcarrier). Additional details regarding the comb structure of the SRS resource are discussed below in connection with FIG. 6.

In some aspects, the UE 120 may be configured with a mapping between SRS ports (e.g., antenna ports) and corresponding SRS resources. The UE 120 may transmit an SRS on a particular SRS resource using an SRS port indicated in the configuration. In some aspects, an SRS resource may span M adjacent symbols within a slot (e.g., where M equals 1, 2, or 4). The UE 120 may be configured with X SRS ports (e.g., where X≤4). In some aspects, each of the X SRS ports may mapped to a corresponding symbol of the SRS resource and used for transmission of an SRS in that symbol.

As shown in FIG. 4, in some aspects, different SRS resource sets indicated to the UE 120 (e.g., having different use cases) may overlap (e.g., in time, in frequency, and/or the like, such as in the same slot). For example, as shown by reference number 415, a first SRS resource set (e.g., shown as SRS Resource Set 1) is shown as having an antenna switching use case. As shown, this example antenna switching SRS resource set includes a first SRS resource (shown as SRS Resource A) and a second SRS resource (shown as SRS Resource B), as indicated by the arrows from the first resource set to the first SRS resource and the second SRS resource. Thus, antenna switching SRS may be transmitted in SRS Resource A (e.g., a first time-frequency resource) using antenna port 0 and antenna port 1 and may be transmitted in SRS Resource B (e.g., a second time-frequency resource) using antenna port 2 and antenna port 3. In this way, SRS may be used to sound the channel via different combinations of antenna ports.

As shown by reference number 420, a second SRS resource set (e.g., shown as SRS Resource Set 2) may be associated with a codebook use case. As shown, this example codebook SRS resource set includes only the first SRS resource (shown as SRS Resource A). Thus, codebook SRS may be transmitted in SRS Resource A (e.g., the first time-frequency resource) using antenna port 0 and antenna port 1, and the UE 120 may not transmit codebook SRS in SRS Resource B (e.g., the second time-frequency resource) using antenna port 2 and antenna port 3.

In some aspects, SRS transmissions from different UEs may be multiplexed using time division multiple access (TDMA), frequency division multiple access (FDMA), and/or code division multiple access (CDMA).

As described herein, a UE (such as a RedCap UE) may transmit SRSs that are used for uplink channel estimation, such as for scheduling, link adaptation, precoder selection, or beam management. The SRSs are transmitted based at least in part on a configuration of an SRS resource, which may be configured with a comb-like structure. For example, an SRS transmitted on an SRS resource may be transmitted using a configuration of the SRS resource. In some aspects, the SRS resource may be dependent on the frequency hopping pattern of the RedCap UE (e.g., the SRS resource may “hop with” the frequency hopping pattern of the RedCap UE). In some aspects, the comb-like structure may cause an SRS to be transmitted, for example, every other subcarrier (N=2) or every fourth subcarrier (N=4).

As also described herein, a RedCap UE may generally have one or more reduced features when compared to a non-RedCap (e.g., premium or legacy) UE. For example, relative to a non-RedCap UE, the RedCap UE may support a lower maximum transmit power, may have a less advanced beamforming capability, may have a smaller maximum bandwidth, may have fewer antennas and/or antenna ports, may be restricted to half-duplex communication, and/or may have a lower power class. In some aspects, the RedCap UE may communicate (e.g., transmit or receive) using a NBWP BW that has a maximum bandwidth of 100 MHz. In contrast, the BWP BW of the non-RedCap UE may be larger, for example, having a maximum bandwidth of 400 MHZ (though these bandwidths are provided merely as examples).

In some aspects, an SRS resource of a first UE may partially overlap with an SRS resource of a second UE. For example, an SRS resource of a RedCap UE using a NBWP BW may at least partially overlap with an SRS resource of a non-RedCap UE using a larger BWP BW. In other words, the SRS resource of the RedCap UE may partially overlap in time and/or frequency with the SRS resource of the non-RedCap UE for one or more frequency hops of the NBWP frequency hopping configuration of the RedCap UE. A full overlap between the SRS resource of the RedCap UE and the SRS resource of the non-RedCap UE (where the SRS resources occupy the same time and frequency resources) may not result in a loss of orthogonality. For example, the SRS transmissions on those fully-overlapped resources may be multiplexed together to maintain orthogonality. In contrast, the partial overlap between the SRS resource of the RedCap UE and the SRS resource of the non-RedCap UE may result in a loss of orthogonality since SRS transmissions based at least in part on those resources may not occupy the same time and/or frequency resource, thereby causing interference and resulting in performance loss or a deterioration of communications. Furthermore, the RedCap UE may use BWP frequency hopping, whereas the non-RedCap UE may use a fixed (e.g., non-hopping) BWP. It may be impractical, and/or may involve significant signaling overhead and computational complexity, for a base station to initially configure the SRSs of the RedCap UE and the non-RedCap UE not to interfere with each other, particularly where a base station configures many RedCap UEs with different BWP frequency hopping patterns or where the number of UEs associated with the base station changes over time.

Techniques and apparatuses described herein provide a configuration of the SRS resource of a UE such as a RedCap UE to be changed or updated for one or more BWP frequency hops. For example, the configuration may be changed or updated to eliminate or reduce the overlap with the SRS resource of the non-RedCap UE. For example, the RedCap UE may receive, from a base station, an indication to update a configuration of the SRS resource of the RedCap UE. The indication from the base station (sometimes referred to as a second configuration, where the configuration of the SRS resource of the RedCap UE that was associated with the partial overlap may be referred to as a first configuration) may indicate to update the configuration of the SRS resource for one or more frequency hops of the BWP frequency hopping configuration of the RedCap UE that partially overlaps with the SRS resource of the non-RedCap UE. The RedCap UE may update the configuration of the SRS resource automatically based at least in part on receiving the updated configuration from the base station. Updating the configuration of the SRS resource may include a shift in time of the SRS resource of the RedCap UE. Additionally, or alternatively, updating the configuration of the SRS resource may include a shift in frequency of the SRS resource of the RedCap UE.

Once the configuration of the SRS resource has been updated, the RedCap UE may transmit one or more SRSs that are based at least in part on the updated configuration of the SRS resource of the RedCap UE. For example, the transmission of the SRSs will have been shifted in time and/or frequency such that the SRS transmission by the RedCap UE does not partially overlap with a transmission by the non-RedCap UE using the frequency hopping pattern of the non-RedCap UE. In other words, the SRS transmission of the RedCap UE that is based at least in part on the updated configuration of the SRS resource may be orthogonal to an SRS transmission of the non-RedCap UE. Thus, performance loss or deterioration of communications as a result of interference between those transmissions is reduced or eliminated.

It should be noted that many of the examples described herein relate to resolution of an SRS overlap by modifying the configuration of an SRS resource in one or more frequency hops. However, the techniques described herein can be used to modify the configuration of an SRS resource in one or more frequency hops in the absence of an SRS overlap and/or for reasons unrelated to an SRS overlap.

As indicated above, FIG. 4 is provided as an example. Other examples may differ from what is described with regard to FIG. 4.

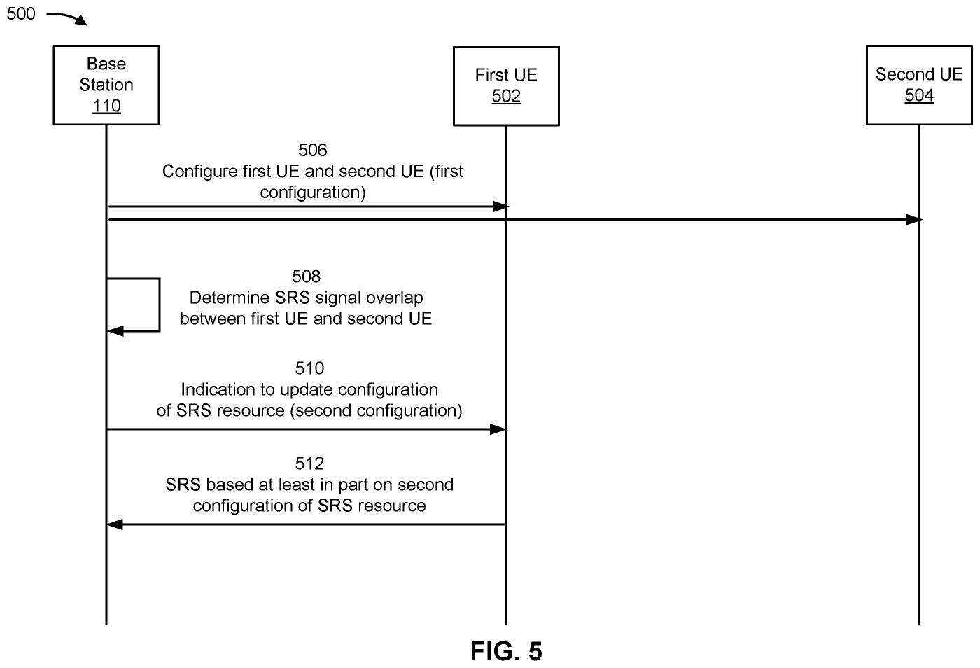

FIG. 5 is a diagram illustrating an example 500 of SRS multiplexing during BWP part hopping, in accordance with the present disclosure. As shown in FIG. 5, a base station, such as the base station 110, and one or more UEs, such as the first UE 502 and the second UE 504, are in communication. In some aspects, the first UE 502 and/or the second UE 504 may be examples of the UE 120 shown in FIG. 1.

As shown in connection with reference number 506, the base station 110 may transmit, and the first UE 502 may receive, configuration information associated with the first UE 502. The first UE 502 may be a UE that has one or more reduced capabilities, such as a RedCap UE. For example, the RedCap UE may operate within a NBWP bandwidth (e.g., less than 100 MHz) and/or may have a lower transmit power as compared to a non-RedCap UE. The configuration information associated with the first UE 502 may include an indication to use a BWP frequency hopping configuration, such as a NBWP frequency hopping configuration. Additionally, or alternatively, the configuration information may include the BWP frequency hopping configuration. As described herein, BWP frequency hopping may be used by the first UE 502 to improve frequency diversity within a narrower band of operation and to reduce or eliminate frequency-selective interference. In some aspects, the configuration information may be transmitted via radio resource control (RRC) signaling. In some aspects, the configuration information may be transmitted via medium access control (MAC) signaling (e.g., a MAC control element (MAC-CE)) or downlink control information (DCI).

In some aspects, the base station 110 may transmit, and the second UE 504 may receive, configuration information associated with the second UE 504. In some aspects, the second UE 504 may be a non-RedCap UE, such as a legacy UE or a premium UE. As described herein, a non-RedCap UE may operate within a larger BWP bandwidth (e.g., less than or equal to 400 MHZ, though wider bandwidths may be used) and may have a higher transmit power as compared to the RedCap UE. The configuration information of the second UE 504 may include an indication to use a fixed (e.g., non-hopping) BWP. For example, the configuration information may provide a BWP configuration for the fixed BWP and/or may activate the fixed BWP. Alternatively, the configuration information of the second UE 504 may include an indication to implement frequency hopping within the larger BWP associated with the second UE 504.

The configuration information associated with the first UE 502 may include configuration information associated with an SRS resource to allocate resources for SRS transmissions by the first UE 502. For example, the configuration information may indicate a first configuration for the SRS resource. The configuration information associated with the second UE 504 may include configuration information associated with an SRS resource to allocate resources for SRS transmissions by the second UE 504. The SRSs may be used by the base station 110 for uplink channel estimation, such as for scheduling, link adaptation, precoder selection, or beam management, among other examples. The base station 110 may configure one or more SRS resources for the first UE 502 and/or the second UE 504, and one or more SRSs may be transmitted on the configured SRS resources. In some aspects, the base station 110 may measure the SRSs from the first UE 502 and/or the second UE 504, may perform channel estimation based at least in part on the measurements, and may use the SRS measurements to configure communications with the first UE 502 and/or the second UE 504.

As shown in connection with reference number 508, the base station 110 may identify (e.g., determine) an SRS signal overlap between the first UE 502 and the second UE 504. The base station 110 may determine, based at least in part on the first configuration for the SRS resource of the first UE 502, that the SRS resource of the first UE 502 partially overlaps with an SRS resource of the second UE 504 for one or more frequency hops of the BWP frequency hopping configuration of the first UE 502. For example, at least a portion of the SRS resource of the first UE 502 may overlap (e.g., interfere) with the SRS resource of the second UE 504 for one or more frequency hops of the BWP frequency hopping configuration of the first UE 502. The SRS resource of the first UE 502 may overlap with the SRS resource of the second UE in the time domain and/or in the frequency domain.

As described herein, a full overlap between the SRS resource of the first UE 502 and the SRS resource of the second UE 504 (where the SRS resources occupy the same time and frequency resources) may not result in a loss of orthogonality of SRSs of the first UE 502 and the second UE 504. For example, SRSs transmitted on these fully overlapped resources may be generated using sequences that are orthogonal to each other if the resources are fully overlapped, and therefore, orthogonality may be maintained. In contrast, a partial overlap between the SRS resource of the first UE 502 and the SRS resource of the second UE 504 may result in a loss of orthogonality because the sequences are designed to be orthogonal for fully overlapped resources, causing interference and resulting in performance loss or a deterioration of communications.

In some aspects, the bandwidth of the SRS resource of the first UE 502 may be smaller than the bandwidth of the SRS resource of the second UE 504. Thus, a loss of orthogonality can occur even if the SRS resource of the first UE 502 and the SRS resource of the second UE 504 are transmitted on the same frequency resource. Because the SRS resource of the first UE 502 and the SRS resource of the second UE 504 do not occupy the same time resource (e.g., if the SRS resource of the first UE 502 occupies one symbol and the SRS resource of the second UE 504 occupies two symbols), the SRS resources are not truly orthogonal, resulting in interference between SRSs transmitted on those resources.

As shown in connection with reference number 510, the base station 110 may transmit, and the first UE 502 may receive, a second configuration of the SRS resource. For example, the second configuration may include an indication to update the first configuration of the SRS resource of the first UE 502. The indication may be an indication to update a first configuration of the SRS resource of the first UE 502 for one or more frequency hops of the BWP frequency hopping configuration of the first UE 502. The base station 110 may transmit the second configuration of the SRS resource of the first UE 502 based at least in part on determining that the SRS resource of the first UE 502 partially overlaps with the SRS resource of the second UE 504. For example, the SRS resource of the first UE 502 may partially overlap with the SRS resource of the second UE 504 in the one or more frequency hops to which the indication relates. It should be noted that, in some aspects, the second configuration may indicate an update to a first configuration of the SRS resource, and may not be a standalone configuration of an SRS resource. For example, the second configuration may modify one or more parameters of the first configuration in one or more frequency hops. The second configuration can be communicated via RRC, MAC, or DCI signaling.

In some aspects, the second configuration of the first UE 502 may be received in an RRC message. The RRC message may indicate a mapping between the BWP frequency hopping configuration and the updated configuration of the SRS resource of the first UE 502. For example, the RRC message may indicate whether or not the updated configuration applies to one or more frequency hops of the BWP frequency hopping configuration (e.g., based at least in part on a bitmap, an indication of a range of frequency hops, an explicit identification of the one or more frequency hops, or the like). The first UE may be configured to update (e.g., automatically) the configuration of the SRS resource of the first UE 502 based at least in part on receiving the RRC message. In some aspects, the second configuration of the SRS resource of the first UE 502 may be received in DCI. The DCI may override the first configuration of the SRS resource of the first UE 502 as identified in an initial RRC configuration. In some aspects, the second configuration of the SRS resource of the first UE 502 may be received in a MAC message. The MAC message may override the configuration of the SRS resource of the first UE 502 as identified in the initial RRC configuration. Thus, the first UE 504 may update one or more RRC parameters of the BWP frequency hopping configuration based at least in part on the DCI or the MAC message, which reduces overhead and latency relative to reconfiguring the one or more RRC parameters via RRC signaling.

In some aspects, the second configuration may comprise a shift in time (e.g., a shift of a symbol) of the SRS resource of the first UE 502. For example, the SRS resource of the first UE 502 may be shifted in time such that the SRS resource of the first UE 502 does not overlap with the SRS resource of the second UE 504. In some aspects, the second configuration may comprise a shift in frequency (e.g., a shift of a resource element or tone) of the SRS resource of the first UE 502. For example, the SRS resource of the first UE 502 may be shifted in frequency such that the SRS resource of the first UE 502 does not overlap with the SRS resource of the second UE 504. In some aspects, the second configuration may comprise at least one of an update to a comb structure of the SRS resource of the first UE 502 (e.g., from two to four), an update to a number of symbols of the SRS resource of the first UE 502, an update to a sequence parameter (e.g., Zadoff-Chu sequence parameter) of the SRS resource of the first UE 502 (e.g., root or shift), or a skip of an SRS transmission on the SRS resource of the first UE 502. In some aspects, the updated configuration may comprise a combination of two or more of a shift in time, a shift in frequency, an update to a comb structure, an update to a number of symbols, or an update to a sequence parameter. In some aspects, the updated configuration may indicate to skip an SRS transmission, as described below. Additional details regarding the second configuration of the SRS resource of the first UE 502 are described below in connection with FIG. 6.

As shown in connection with reference number 512, the first UE 502 may transmit, and the base station 110 may receive, an SRS that is based at least in part on the second configuration of the SRS resource of the first UE 502. In some aspects, transmitting an SRS based at least in part on the second configuration of the SRS resource of the first UE may include transmitting the SRS in a non-overlapping SRS resource (e.g., an SRS resource that does not overlap with the SRS resource of the second UE). Additionally, or alternatively, transmitting the SRS based at least in part on the updated configuration of the SRS resource of the first UE may include skipping at least one SRS transmission in the one or more frequency hops of the BWP frequency hopping configuration.

In some aspects, the indication to update the configuration of the SRS resource of the first UE 502 may include signaling that the first UE 502 should switch to a BWP. For example, the updated configuration may indicate that the first UE 502 should switch to a third BWP that does not overlap with the BWP of the second UE 504. In some aspects, the third BWP may overlap with the BWP of the second UE 504, but the third BWP may be configured not to interfere with the BWP of the second UE 504. Switching to the BWP indicated in the updated configuration may include activating the third BWP prior to switching. For example, the first UE 502 may be configured to activate the third BWP of the first UE 502, and to switch to the third BWP for transmitting one or more SRSs. Since the third BWP of the first UE 502 does not partially overlap with the BWP of the second UE 504, SRS transmissions by the first UE 502 based at least in part on the third BWP and the frequency hopping pattern of the first UE 502 will not interfere with transmissions by the second UE 504.

As described above, the first UE 502 may receive a second configuration (e.g., an indication to update a configuration) that causes an SRS resource of the first UE 502 to be shifted in time and/or frequency such that a partial overlap between the SRS resource of the first UE 502 and an SRS resource of the second UE 504 is resolved. SRS transmissions that are based at least in part on the updated configuration of the SRS resource of the first UE 502 will not partially overlap (e.g., the SRS resources may not overlap at all, or the SRS resources may fully overlap) with SRS transmissions that are based at least in part on the SRS resource of the second UE 504, thereby eliminating or reducing interference between transmissions by the first UE 502 and the second UE 504.

As indicated above, FIG. 5 is provided as an example. Other examples may differ from what is described with regard to FIG. 5.

FIG. 6 is a diagram illustrating an example 600 of SRS resource configuration, in accordance with the present disclosure. As shown in FIG. 6, a first UE (e.g., the first UE 502) may be configured to communicate using a first BWP. In some examples, the first BWP may be a NBWP, such as a BWP having a maximum bandwidth of 100 MHz. The first UE 502 may be configured to transmit one or more SRSs based at least in part on an SRS resource of the first BWP, such as the SRS resource 602. The SRS resource 602 may include a number of resources (e.g., resource elements) on which the first UE 502 may transmit SRSs. For example, the five “shaded” resources of the first BWP correspond to resources that the first UE 502 may use for SRS transmission. An example of one of the resources of the first SRS resource 602 is identified by reference numbers 602a. In contrast, the “non-shaded” subcarriers are not part of the SRS resource, and thus correspond to resources on which the first UE 502 does not transmit SRSs. In some aspects, the first UE 502 may communicate according to a BWP frequency hopping configuration. The resources of the SRS resource 602 may be based at least in part on the frequency hopping configuration of the first UE 502.

As also shown in FIG. 6, a second UE (e.g., the second UE 504) may be configured to communicate using a second BWP. The second BWP may be a larger BWP than the first BWP, such as a BWP having a maximum bandwidth of 400 MHz. The second UE 504 may be configured to transmit one or more SRSs based at least in part on an SRS resource of the second BWP, such as the SRS resource 604. The SRS resource 604 may include a number of resources on which the second UE 504 may transmit SRSs. For example, the eight resources of the second BWP that are illustrated with a hatched fill correspond to resources that the second UE 504 may use for SRS transmission. An example of one of the resources of the SRS resource 604 is identified as 604a. In contrast, the resources with no fill are not part of the SRS resource 604, and thus correspond to resources on which second UE 504 does not transmit SRSs. In some aspects, the second UE 504 may communicate according to a fixed (e.g., non-hopping) BWP configuration. The resources of the SRS resource 604 may be based at least in part on the fixed configuration of the second UE 504.

As described above in connection with FIG. 5, it may be determined that the SRS resource 602 of the first UE 502 partially overlaps with the SRS resource 604 of the second UE 604. For example, the base station 110 may determine (e.g., identify) that the SRS resource 602 partially overlaps with the SRS resource 604 for one or more frequency hops of the first BWP frequency hopping configuration of the first UE 502. The base station 110 may make this determination based at least in part on a first configuration of the SRS resource 602 and a configuration of the SRS resource 604. The SRS resource 602 may partially overlap with the SRS resource 604 in time and/or frequency. As shown in FIG. 6, resource 602a of SRS resource 602 partially overlaps in time and frequency with resource 604a of SRS resource 604.

As described herein, a full overlap between the SRS resource 602 of the first UE 502 and the SRS resource 604 of the second UE 504 (where the SRS resources occupy the same time and frequency resources) may not result in a loss of orthogonality. In contrast, a partial overlap between the SRS resource 602 and the SRS resource 604 may result in a loss of orthogonality, causing interference and resulting in performance loss or a deterioration of communications. As shown in the example of FIG. 6, there exists a partial overlap between the SRS resource 602 and the SRS resource 604 since at least one resource (e.g., resource 602a) of the SRS resource 602 overlaps in time and frequency with a resource (e.g., resource 604a) of the SRS resource 604. However, a full overlap between the SRS resources does not exist since at least one resource of the SRS resource 604 on the second BWP does not have a corresponding resource of the SRS resource 602 on the first BWP.

In some aspects, the bandwidth of the SRS resource 602 may be smaller than the bandwidth of the SRS resource 604. This is shown in the example of FIG. 6, where the SRS resource 602 is made up of five individual resources spanning nine subcarriers, whereas the SRS resource 604 is made up of eight individual resources spanning fifteen subcarriers. Thus, it is possible that a loss of orthogonality can occur even if at least part of the SRS resource 602 and the SRS resource 604 are transmitted on the same frequency resource, since there is not a complete overlap between the resources.

As described above in connection with FIG. 5, the base station 110 may transmit, to the first UE 502, a second configuration of the SRS resource 602. For example, the second configuration may include an indication to update a first configuration of the SRS resource 602 (e.g., a configuration that caused the partial overlap) for one or more frequency hops of the BWP frequency hopping configuration of the first UE 502. The base station 110 may transmit the second configuration based at least in part on determining that the SRS resource 602 of the first UE 502 partially overlaps with the SRS resource 604 of the second UE 504. The first UE 502 may be configured to update the configuration of the SRS resource 602 based at least in part on receiving the second configuration.

As shown in the example of FIG. 6, updating the configuration of the SRS resource 602 may include shifting the frequency of the SRS resource 602 based at least in part on receiving the updated configuration. The SRS resource 602 may be shifted in frequency such that the resources of the SRS resource 602 do not overlap with the resources of the SRS resource 604. For example, resource 602a of the SRS resource 602 (shown as resource 602b when shifted in frequency) may be shifted such that resource 602a does not overlap with resource 604a of the SRS resource 604. Similarly, the other resources of the SRS resource 602 may also be shifted in frequency such that they do not overlap with any of the resources of the SRS resource 604. In other words, the resources of the SRS resource 602 of the updated configuration correspond to empty resource elements of the BWP of the second UE 504. The first UE 502 may thereafter transmit one or more SRSs based at least in part on the second configuration, and based at least in part on the BWP frequency hopping configuration of the first UE 502, without causing overlap with transmissions based at least in part on the SRS resource 604 of the second UE 504.

While FIG. 6 shows a shift of the SRS resource 602 in the frequency domain, the SRS resource 602 may additionally, or alternatively, be shifted in the time domain. In other words, the SRS resource 602 may be shifted in the frequency domain, in the time domain, or in both the frequency domain and the time domain. In some aspects, one or more resources of the SRS resources 602 may be shifted in time such the resources of the SRS resource 602 do not overlap with any of the resources of the SRS resource 604.

Additionally, or alternatively, to the shift in the frequency domain and/or the shift in the time domain, the second configuration of the SRS resource 602 may comprise one or more of an update to a comb structure of the SRS resource 602, an update to a number of symbols of the SRS resource 602, an update to a sequence parameter of the SRS resource 602, or a skip of an SRS transmission on the SRS resource 602.

As described above, the first UE 502 may transmit one or more SRSs based at least in part on the second configuration of the SRS resource 602. The one or more SRS transmissions that are based at least in part on the second configuration do not partially overlap with SRS transmissions that are based at least in part on the SRS resource 604 of the second UE 504, thereby eliminating or reducing interference between the transmissions by the first UE 502 and the second UE 504.

As indicated above, FIG. 6 is provided as an example. Other examples may differ from what is described with regard to FIG. 6.

FIG. 7 is a diagram illustrating an example process 700 performed, for example, by a first UE, in accordance with the present disclosure. Example process 700 is an example where the first UE (e.g., UE 120) performs operations associated with techniques for sounding reference signal multiplexing during bandwidth part hopping.

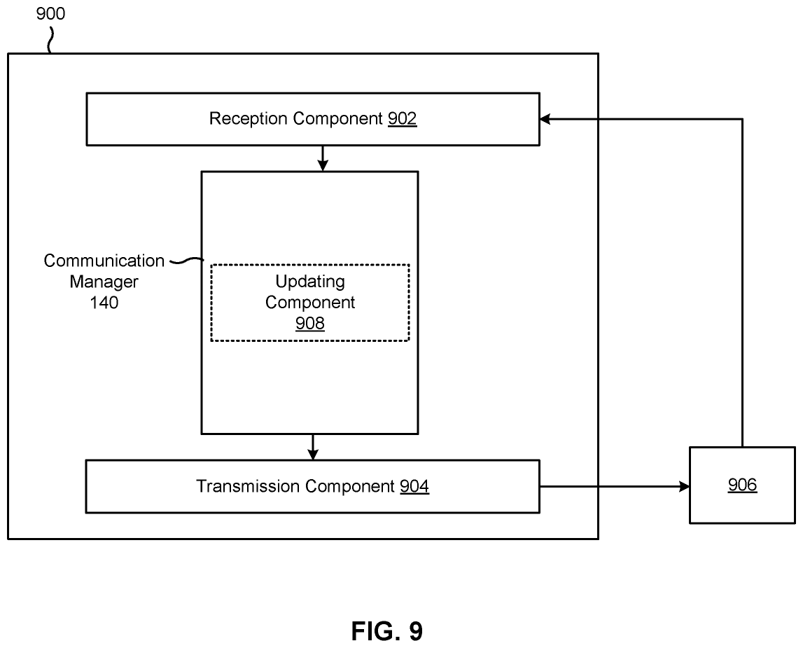

As shown in FIG. 7, in some aspects, process 700 may include receiving a bandwidth part (BWP) frequency hopping configuration for a BWP (block 710). For example, the first UE (e.g., using communication manager 140 and/or reception component 902, depicted in FIG. 9) may receive a bandwidth part (BWP) frequency hopping configuration for a BWP, as described above.

As shown in FIG. 7, in some aspects, process 700 may include receiving a first configuration of a sounding reference signal (SRS) resource (block 720). For example, the first UE (e.g., using communication manager 140 and/or reception component 902, depicted in FIG. 9) may receive a first configuration of a sounding reference signal (SRS) resource, as described above.

As further shown in FIG. 7, in some aspects, process 700 may include receiving a second configuration of the SRS resource for one or more frequency hops of the BWP frequency hopping configuration (block 730). For example, the first UE (e.g., using communication manager 140 and/or reception component 902, depicted in FIG. 9) may receive a second configuration of the SRS resource for one or more frequency hops of the BWP frequency hopping configuration. In some aspects, the second configuration resolves a partial overlap of the SRS resource with an SRS resource of a second UE in the one or more frequency hops, as described above.

As further shown in FIG. 7, in some aspects, process 700 may include transmitting one or more SRSs based at least in part on the second configuration of the SRS resource (block 740). For example, the first UE (e.g., using communication manager 140 and/or transmission component 904, depicted in FIG. 9) may transmit one or more SRSs based at least in part on the second configuration of the SRS resource, as described above.

Process 700 may include additional aspects, such as any single aspect or any combination of aspects described below and/or in connection with one or more other processes described elsewhere herein.

In a first aspect, the second configuration resolves a partial overlap of the SRS resource with an SRS resource of a second UE in the one or more frequency hops

In a second aspect, alone or in combination with the first aspect, transmitting the one or more SRSs based at least in part on the second configuration of the SRS resource comprises transmitting the one or more SRSs in a non-overlapping SRS resource.

In a third aspect, alone or in combination with one or more of the first and second aspects, the non-overlapping SRS resource does not overlap with the SRS resource of the second UE.

In a fourth aspect, alone or in combination with one or more of the first through third aspects, transmitting the one or more SRSs based at least in part on the second configuration of the SRS resource comprises skipping at least one SRS transmission in the one or more frequency hops of the BWP frequency hopping configuration.

In a fifth aspect, alone or in combination with one or more of the first through fourth aspects, the first UE is a reduced capability (RedCap) UE.

In a sixth aspect, alone or in combination with one or more of the first through fifth aspects, the first UE has a reduced capability compared to the second UE.

In a seventh aspect, alone or in combination with one or more of the first through sixth aspects, a BWP bandwidth of the first UE is smaller than a BWP bandwidth of the second UE.

In an eighth aspect, alone or in combination with one or more of the first through seventh aspects, a bandwidth of the SRS resource is smaller than a bandwidth of the SRS resource of the second UE.

In a ninth aspect, alone or in combination with one or more of the first through eighth aspects, in the first configuration, the SRS resource partially overlaps with the SRS resource of the second UE in at least one of a time domain or a frequency domain.

In a tenth aspect, alone or in combination with one or more of the first through ninth aspects, the second configuration comprises at least one of a shift in time of the SRS resource or a shift in frequency of the SRS resource.

In an eleventh aspect, alone or in combination with one or more of the first through tenth aspects, the second configuration further comprises at least one of an update to a comb structure of the SRS resource, an update to a number of symbols of the SRS resource, an update to a sequence parameter of the SRS resource, or a skip of an SRS transmission on the SRS resource.

In a twelfth aspect, alone or in combination with one or more of the first through eleventh aspects, the second configuration is received in a radio resource control (RRC) message.

In a thirteenth aspect, alone or in combination with one or more of the first through twelfth aspects, process 700 includes updating the configuration of the SRS resource based at least in part on receiving the RRC message.

In a fourteenth aspect, alone or in combination with one or more of the first through thirteenth aspects, the RRC message indicates a mapping between the BWP frequency hopping configuration and the second configuration of the SRS resource.

In a fifteenth aspect, alone or in combination with one or more of the first through fourteenth aspects, the second configuration of the SRS resource includes signaling to switch the first UE to a BWP, and wherein transmitting the one or more SRSs based at least in part on the second configuration further comprises transmitting the one or more SRS based at least in part on the second configuration based at least in part on switching to the BWP.

In a sixteenth aspect, alone or in combination with one or more of the first through fifteenth aspects, the second configuration of the SRS resource is received in one of downlink control information (DCI) or a medium access control (MAC) message.

In a seventeenth aspect, alone or in combination with one or more of the first through sixteenth aspects, the DCI or the MAC message overrides the configuration of the SRS resource as identified in a radio resource control (RRC) configuration.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a base station, in accordance with the present disclosure. Example process 800 is an example where the base station (e.g., base station 110) performs operations associated with techniques for sounding reference signal multiplexing during bandwidth part hopping.

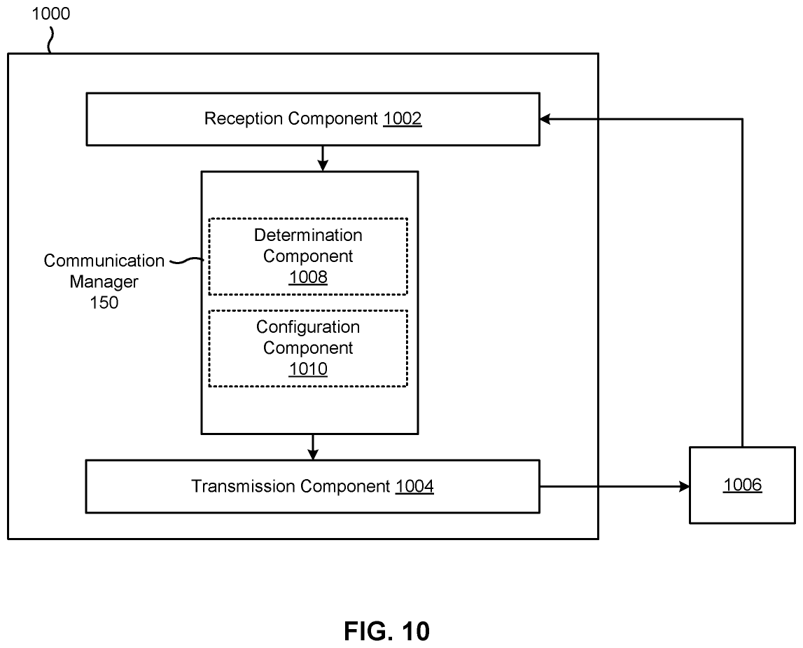

As shown in FIG. 8, in some aspects, process 800 may include transmitting, to a first user equipment (UE), a bandwidth part (BWP) frequency hopping configuration (block 810). For example, the base station (e.g., using communication manager 150 and/or transmission component 1004, depicted in FIG. 10) may transmit, to a first user equipment (UE), a bandwidth part (BWP) frequency hopping configuration and a first configuration of a sounding reference signal (SRS) resource, as described above.

As shown in FIG. 8, in some aspects, process 800 may include transmitting, to the first UE, a first configuration of a sounding reference signal (SRS) resource (block 820). For example, the base station (e.g., using communication manager 150 and/or transmission component 1004, depicted in FIG. 10) may transmit, to the first UE, a first configuration of a sounding reference signal (SRS) resource, as described above.

As further shown in FIG. 8, in some aspects, process 800 may include determining, based at least in part on the first configuration, that the SRS resource partially overlaps with an SRS resource of a second UE for one or more frequency hops of the BWP frequency hopping configuration (block 830). For example, the base station (e.g., using communication manager 150 and/or determination component 1008, depicted in FIG. 10) may optionally determine, based at least in part on the first configuration, that the SRS resource partially overlaps with an SRS resource of a second UE for one or more frequency hops of the BWP frequency hopping configuration, as described above.

As further shown in FIG. 8, in some aspects, process 800 may include transmitting a second configuration of the SRS resource for the one or more frequency hops of the BWP frequency hopping configuration (block 830). For example, the base station (e.g., using communication manager 150 and/or transmission component 1004, depicted in FIG. 10) may transmit a second configuration of the SRS resource for the one or more frequency hops of the BWP frequency hopping configuration. In some aspects, the base station may transmit the second configuration based at least in part on determining that the SRS resource partially overlaps with the SRS resource of the second UE, as described above.

As further shown in FIG. 8, in some aspects, process 800 may include receiving one or more SRSs based at least in part on the second configuration of the SRS resource (block 840). For example, the base station (e.g., using communication manager 150 and/or reception component 1002, depicted in FIG. 10) may receive one or more SRSs based at least in part on the second configuration of the SRS resource, as described above.

Process 800 may include additional aspects, such as any single aspect or any combination of aspects described below and/or in connection with one or more other processes described elsewhere herein.

In a first aspect, receiving the one or more SRSs based at least in part on the second configuration of the SRS resource comprises receiving the one or more SRSs in a non-overlapping SRS resource.

In a second aspect, alone or in combination with the first aspect, the non-overlapping SRS resource does not overlap with the SRS resource of the second UE.

In a third aspect, alone or in combination with one or more of the first and second aspects, the first UE is a reduced capability (RedCap) UE.

In a fourth aspect, alone or in combination with one or more of the first through third aspects, the second UE is not a reduced capability (RedCap) UE.

In a fifth aspect, alone or in combination with one or more of the first through fourth aspects, the first UE has a reduced capability compared to the second UE.

In a sixth aspect, alone or in combination with one or more of the first through fifth aspects, a BWP bandwidth of the first UE is smaller than a BWP bandwidth of the second UE.

In a seventh aspect, alone or in combination with one or more of the first through sixth aspects, process 800 includes configuring the BWP bandwidth of the first UE, and configuring the BWP bandwidth of the second UE.

In an eighth aspect, alone or in combination with one or more of the first through seventh aspects, a bandwidth of the SRS resource is smaller than a bandwidth of the SRS resource of the second UE.

In a ninth aspect, alone or in combination with one or more of the first through eighth aspects, determining that the SRS resource partially overlaps with the SRS resource of the second UE comprises determining, based at least in part on the first configuration, that the SRS resource partially overlaps with the SRS resource of the second UE in at least one of a time domain or a frequency domain.

In a tenth aspect, alone or in combination with one or more of the first through ninth aspects, the second configuration comprises at least one of a shift in time of the SRS resource or a shift in frequency of the SRS resource.

In an eleventh aspect, alone or in combination with one or more of the first through tenth aspects, the second configuration further comprises at least one of an update to a comb structure of the SRS resource, an update to a number of symbols of the SRS resource, an update to a sequence parameter of the SRS resource, or a skip of an SRS transmission on the SRS resource.

In a twelfth aspect, alone or in combination with one or more of the first through eleventh aspects, the second configuration is indicated in a radio resource control (RRC) message.

In a thirteenth aspect, alone or in combination with one or more of the first through twelfth aspects, the RRC message indicates a mapping between the BWP frequency hopping configuration and the second configuration of the SRS resource.

In a fourteenth aspect, alone or in combination with one or more of the first through thirteenth aspects, the second configuration of the SRS resource is indicated in one of downlink control information (DCI) or a medium access control (MAC) message.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication. The apparatus 900 may be a first UE (e.g., the first UE 502), or a first UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 140. The communication manager 140 may include an updating component 908, among other examples.

In some aspects, the apparatus 900 may be configured to perform one or more operations described herein in connection with FIGS. 5-6. Additionally, or alternatively, the apparatus 900 may be configured to perform one or more processes described herein, such as process 700 of FIG. 7. In some aspects, the apparatus 900 and/or one or more components shown in FIG. 9 may include one or more components of the first UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the first UE described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the first UE described in connection with FIG. 2. In some aspects, the transmission component 904 may be co-located with the reception component 902 in a transceiver.

The reception component 902 may receive a bandwidth part (BWP) frequency hopping configuration for a BWP and a first configuration of a sounding reference signal (SRS) resource. The reception component 902 may receive a second configuration of the SRS resource for one or more frequency hops of the BWP frequency hopping configuration. The transmission component 904 may transmit one or more SRSs based at least in part on the second configuration of the SRS resource.

The updating component 908 may update the configuration of the SRS resource based at least in part on receiving the RRC message.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication. The apparatus 1000 may be a base station, or a base station may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 150. The communication manager 150 may include one or more of a determination component 1008 and/or a configuration component 1010, among other examples.

In some aspects, the apparatus 1000 may be configured to perform one or more operations described herein in connection with FIGS. 5-6. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the base station described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the base station described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the base station described in connection with FIG. 2. In some aspects, the transmission component 1004 may be co-located with the reception component 1002 in a transceiver.

The transmission component 1004 may transmit, to a first user equipment (UE), a bandwidth part (BWP) frequency hopping configuration and a first configuration of a sounding reference signal (SRS) resource. The determination component 1008 may determine, based at least in part on the first configuration, that the SRS resource partially overlaps with an SRS resource of a second UE for one or more frequency hops of the BWP frequency hopping configuration. The transmission component 1004 may transmit a second configuration of the SRS resource for the one or more frequency hops of the BWP frequency hopping configuration. The reception component 1002 may receive one or more SRSs based at least in part on the second configuration of the SRS resource.

The configuration component 1010 may configure the BWP bandwidth of the first UE and/or the BWP bandwidth of the second UE.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a first user equipment (UE), comprising: receiving a bandwidth part (BWP) frequency hopping configuration for a BWP; receiving a first configuration of a sounding reference signal (SRS) resource; receiving a second configuration of the SRS resource for one or more frequency hops of the BWP frequency hopping configuration; and transmitting one or more SRSs based at least in part on the second configuration of the SRS resource.

Aspect 2: The method of Aspect 1, wherein transmitting the one or more SRSs based at least in part on the second configuration of the SRS resource comprises transmitting the one or more SRSs in a non-overlapping SRS resource.

Aspect 3: The method of Aspect 2, wherein the non-overlapping SRS resource does not overlap with the SRS resource of the second UE.

Aspect 4: The method of any of Aspects 1-3, wherein transmitting the one or more SRSs based at least in part on the second configuration of the SRS resource comprises skipping at least one SRS transmission in the one or more frequency hops of the BWP frequency hopping configuration.

Aspect 5: The method of any of Aspects 1-4, wherein the first UE is a reduced capability (RedCap) UE.

Aspect 6: The method of any of Aspects 1-5, wherein the first UE has a reduced capability compared to the second UE.

Aspect 7: The method of any of Aspects 1-6, wherein a BWP bandwidth of the first UE is smaller than a BWP bandwidth of the second UE.

Aspect 8: The method of any of Aspects 1-7, wherein a bandwidth of the SRS resource is smaller than a bandwidth of the SRS resource of the second UE.

Aspect 9: The method of any of Aspects 1-8, wherein, in the first configuration, the SRS resource partially overlaps with the SRS resource of the second UE in at least one of a time domain or a frequency domain.

Aspect 10: The method of any of Aspects 1-9, wherein the second configuration comprises at least one of a shift in time of the SRS resource or a shift in frequency of the SRS resource.

Aspect 11: The method of any of Aspects 1-10, wherein the second configuration further comprises at least one of an update to a comb structure of the SRS resource, an update to a number of symbols of the SRS resource, an update to a sequence parameter of the SRS resource, or a skip of an SRS transmission on the SRS resource.

Aspect 12: The method of any of Aspects 1-11, wherein the second configuration is received in a radio resource control (RRC) message.

Aspect 13: The method of Aspect 12, further comprising updating the configuration of the SRS resource based at least in part on receiving the RRC message.

Aspect 14: The method of Aspect 12, wherein the RRC message indicates a mapping between the BWP frequency hopping configuration and the second configuration of the SRS resource.

Aspect 15: The method of any of Aspects 1-14, wherein the second configuration of the SRS resource includes signaling to switch the first UE to a BWP, and wherein transmitting the one or more SRSs based at least in part on the second configuration further comprises: transmitting the one or more SRS based at least in part on the second configuration based at least in part on switching to the BWP.

Aspect 16: The method of any of Aspects 1-15, wherein the second configuration of the SRS resource is received in one of downlink control information (DCI) or a medium access control (MAC) message.

Aspect 17: The method of any of Aspects 1-16, wherein the DCI or the MAC message overrides the configuration of the SRS resource as identified in a radio resource control (RRC) configuration.

Aspect 18: A method of wireless communication performed by a base station, comprising: transmitting, to a first user equipment (UE), a bandwidth part (BWP) frequency hopping configuration; receiving a first configuration of a sounding reference signal (SRS) resource; determining, based at least in part on the first configuration, that the SRS resource partially overlaps with an SRS resource of a second UE for one or more frequency hops of the BWP frequency hopping configuration; transmitting a second configuration of the SRS resource for the one or more frequency hops of the BWP frequency hopping configuration based at least in part on determining that the SRS resource partially overlaps with the SRS resource of the second UE; and receiving one or more SRSs based at least in part on the second configuration of the SRS resource.

Aspect 19: The method of Aspect 18, wherein receiving the one or more SRSs based at least in part on the second configuration of the SRS resource comprises receiving the one or more SRSs in a non-overlapping SRS resource.

Aspect 20: The method of Aspect 19, wherein the non-overlapping SRS resource does not overlap with the SRS resource of the second UE.

Aspect 21: The method of any of Aspects 18-20, wherein the first UE is a reduced capability (RedCap) UE.

Aspect 22: The method of any of Aspects 18-21, wherein the second UE is not a reduced capability (RedCap) UE.

Aspect 23: The method of any of Aspects 18-222, wherein the first UE has a reduced capability compared to the second UE.

Aspect 24: The method of any of Aspects 18-23, wherein a BWP bandwidth of the first UE is smaller than a BWP bandwidth of the second UE.

Aspect 25: The method of Aspect 24, further comprising: configuring the BWP bandwidth of the first UE; and configuring the BWP bandwidth of the second UE.

Aspect 26: The method of any of Aspects 18-25, wherein a bandwidth of the SRS resource is smaller than a bandwidth of the SRS resource of the second UE.

Aspect 27: The method of any of Aspects 18-26, wherein determining that the SRS resource partially overlaps with the SRS resource of the second UE comprises determining, based at least in part on the first configuration, that the SRS resource partially overlaps with the SRS resource of the second UE in at least one of a time domain or a frequency domain.

Aspect 28: The method of any of Aspects 18-27, wherein the second configuration comprises at least one of a shift in time of the SRS resource or a shift in frequency of the SRS resource.

Aspect 29: The method of Aspect 28, wherein the second configuration further comprises at least one of an update to a comb structure of the SRS resource, an update to a number of symbols of the SRS resource, an update to a sequence parameter of the SRS resource, or a skip of an SRS transmission on the SRS resource.

Aspect 30: The method of any of Aspects 18-29, wherein the second configuration is indicated in a radio resource control (RRC) message.

Aspect 31: The method of Aspect 30, wherein the RRC message indicates a mapping between the BWP frequency hopping configuration and the second configuration of the SRS resource.

Aspect 32: The method of any of Aspects 18-31, wherein the second configuration of the SRS resource is indicated in one of downlink control information (DCI) or a medium access control (MAC) message.

Aspect 33: An apparatus for wireless communication at a device, comprising a processor; memory coupled with the processor; and instructions stored in the memory and executable by the processor to cause the apparatus to perform the method of one or more of Aspects 1-17.

Aspect 34: A device for wireless communication, comprising a memory and one or more processors coupled to the memory, the one or more processors configured to perform the method of one or more of Aspects 1-17.

Aspect 35: An apparatus for wireless communication, comprising at least one means for performing the method of one or more of Aspects 1-17.

Aspect 36: A non-transitory computer-readable medium storing code for wireless communication, the code comprising instructions executable by a processor to perform the method of one or more of Aspects 1-17.

Aspect 37: A non-transitory computer-readable medium storing a set of instructions for wireless communication, the set of instructions comprising one or more instructions that, when executed by one or more processors of a device, cause the device to perform the method of one or more of Aspects 1-17.

Aspect 38: An apparatus for wireless communication at a device, comprising a processor; memory coupled with the processor; and instructions stored in the memory and executable by the processor to cause the apparatus to perform the method of one or more of Aspects 18-32.

Aspect 39: A device for wireless communication, comprising a memory and one or more processors coupled to the memory, the one or more processors configured to perform the method of one or more of Aspects 18-32.

Aspect 40: An apparatus for wireless communication, comprising at least one means for performing the method of one or more of Aspects 18-32.

Aspect 41: A non-transitory computer-readable medium storing code for wireless communication, the code comprising instructions executable by a processor to perform the method of one or more of Aspects 18-32.

Aspect 42: A non-transitory computer-readable medium storing a set of instructions for wireless communication, the set of instructions comprising one or more instructions that, when executed by one or more processors of a device, cause the device to perform the method of one or more of Aspects 18-32.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A first user equipment (UE) for wireless communication, comprising:
a memory; and
one or more processors, coupled to the memory, configured to:
receive a bandwidth part (BWP) frequency hopping configuration;
receive a first configuration of a sounding reference signal (SRS) resource;
receive a second configuration of the SRS resource for one or more hops indicated by the BWP frequency hopping configuration; and
transmit one or more SRSs based at least in part on the second configuration of the SRS resource.

2. The first UE of claim 1, wherein the second configuration resolves a partial overlap of the SRS resource with an SRS resource of a second UE in the one or more frequency hops.

3. The first UE of claim 2, wherein the one or more processors, to transmit the one or more SRSs based at least in part on the second configuration of the SRS resource, are configured to transmit the one or more SRSs in a non-overlapping SRS resource.

4. The first UE of claim 3, wherein the non-overlapping SRS resource does not overlap with the SRS resource of the second UE.

5. The first UE of claim 2, wherein the first UE has a reduced capability compared to the second UE.

6. The first UE of claim 2, wherein a BWP bandwidth of the first UE is smaller than a BWP bandwidth of the second UE.

7. The first UE of claim 2, wherein a bandwidth of the SRS resource is smaller than a bandwidth of the SRS resource of the second UE.

8. The first UE of claim 2, wherein, in the first configuration, the SRS resource partially overlaps with the SRS resource of the second UE in at least one of a time domain or a frequency domain.

9. The first UE of claim 1, wherein the one or more processors, to transmit the one or more SRSs based at least in part on the second configuration of the SRS resource, are configured to skip at least one SRS transmission in the one or more frequency hops of the BWP frequency hopping configuration.

10. The first UE of claim 1, wherein the second configuration comprises at least one of a shift in time of the SRS resource or a shift in frequency of the SRS resource.

11. The first UE of claim 10, wherein the second configuration further comprises at least one of an update to a comb structure of the SRS resource, an update to a number of symbols of the SRS resource, an update to a sequence parameter of the SRS resource, or a skip of an SRS transmission on the SRS resource.

12. The first UE of claim 1, wherein the second configuration is received in a radio resource control (RRC) message.

13. The first UE of claim 12, wherein the one or more processors are further configured to update the configuration of the SRS resource based at least in part on receiving the RRC message.

14. The first UE of claim 12, wherein the RRC message indicates a mapping between the BWP frequency hopping configuration and the second configuration of the SRS resource.

15. The first UE of claim 1, wherein the second configuration of the SRS resource is received in one of downlink control information (DCI) or a medium access control (MAC) message.

16. A base station for wireless communication, comprising:
a memory; and
one or more processors, coupled to the memory, configured to:
transmit, to a first user equipment (UE), a bandwidth part (BWP) frequency hopping configuration;
transmit, to the first UE, a first configuration of a sounding reference signal (SRS) resource;
transmit a second configuration of the SRS resource for the one or more frequency hops of the BWP frequency hopping configuration; and
receive one or more SRSs based at least in part on the second configuration of the SRS resource.

17. The base station of claim 16, wherein the one or more processors are configured to determine, based at least in part on the first configuration, that the SRS resource partially overlaps with an SRS resource of a second UE for one or more frequency hops of the BWP frequency hopping configuration.

18. The base station of claim 17, wherein a BWP bandwidth of the first UE is smaller than a BWP bandwidth of the second UE.

19. The base station of claim 18, wherein the one or more processors are further configured to:
configure the BWP bandwidth of the first UE; and
configure the BWP bandwidth of the second UE.

20. The base station of claim 17, wherein a bandwidth of the SRS resource is smaller than a bandwidth of the SRS resource of the second UE.

21. The base station of claim 16, wherein the one or more processors, to receive the one or more SRSs based at least in part on the second configuration of the SRS resource, are configured to receive the one or more SRSs in a non-overlapping SRS resource.

22. The base station of claim 16, wherein the second configuration comprises at least one of a shift in time of the SRS resource or a shift in frequency of the SRS resource.

23. The base station of claim 22, wherein the second configuration further comprises at least one of an update to a comb structure of the SRS resource, an update to a number of symbols of the SRS resource, an update to a sequence parameter of the SRS resource, or a skip of an SRS transmission on the SRS resource.

24. The base station of claim 16, wherein the second configuration is indicated in a radio resource control (RRC) message, downlink control information (DCI), or a medium access control (MAC) message.

25. A method of wireless communication performed by a first user equipment (UE), comprising:
receiving a bandwidth part (BWP) frequency hopping configuration for a BWP;
receiving a first configuration of a sounding reference signal (SRS) resource;
receiving a second configuration of the SRS resource for one or more frequency hops of the BWP frequency hopping configuration; and
transmitting one or more SRSs based at least in part on the second configuration of the SRS resource.

26. The method of claim 25, wherein the second configuration resolves a partial overlap of the SRS resource with an SRS resource of a second UE in the one or more frequency hops.

27. The method of claim 26, wherein transmitting the one or more SRSs based at least in part on the second configuration of the SRS resource comprises transmitting the one or more SRSs in a non-overlapping SRS resource.

28. The method of claim 27, wherein the non-overlapping SRS resource does not overlap with the SRS resource of the second UE.

29. A method of wireless communication performed by a base station, comprising:
transmitting, to a first user equipment (UE), a bandwidth part (BWP) frequency hopping configuration;
transmitting, to the first UE, a first configuration of a sounding reference signal (SRS) resource;
transmitting a second configuration of the SRS resource for the one or more frequency hops of the BWP frequency hopping configuration; and
receiving one or more SRSs based at least in part on the second configuration of the SRS resource.

30. The method of claim 29, wherein the second configuration comprises at least one of a shift in time of the SRS resource or a shift in frequency of the SRS resource.
